(19) United States
(12) Patent Application Publication
(10) Pub. No.: US 2013/0096985 A1
(43) Pub. Date: Apr. 18, 2013

(54) SURVEY SYSTEMS AND METHODS USEABLE WITH MOBILE DEVICES AND MEDIA PRESENTATION ENVIRONMENTS

(71) Applicants: Susan Jennifer ROBINSON, Atlanta, GA (US); Alexandra Mazalek, Atlanta, GA (US); Sam Edwin Mendenhall, Atlanta, GA (US); Vedrana Novosel, Cary, NC (US)

(72) Inventors: Susan Jennifer ROBINSON, Atlanta, GA (US); Alexandra Mazalek, Atlanta, GA (US); Sam Edwin Mendenhall, Atlanta, GA (US); Vedrana Novosel, Cary, NC (US)

(73) Assignee: Georgia Tech Research Corporation, Atlanta, GA (US)

(21) Appl. No.: 13/439,584

(22) Filed: Apr. 4, 2012

Related U.S. Application Data
(60) Provisional application No. 61/471,991, filed on Apr. 5, 2011.

(51) Int. Cl. G06Q 30/02

(52) U.S. Cl. CPC G06Q 30/0203
USPC 705/7.32

(57) ABSTRACT

Exemplary survey systems and methods include a survey server and a survey application. The survey application may be installed, or otherwise executable, on remote computing devices. The survey server may deliver surveys to the remote computing devices through the survey application. An exemplary survey includes at least one quantitative query coupled with at least one qualitative query. The quantitative query may be associated with two or more predetermined answer options. The qualitative query may provide an option to include a user-provided entry. For example, the user-provided entry may be a video or audio recording captured by the remote computing device running the mobile survey application. The mobile survey application may transmit the survey response, including with the user-provided entry, and the user location back to the survey server for analysis or display. Other embodiments of the survey systems and methods are also disclosed herein.

### CROSS-REFERENCE TO RELATED APPLICATIONS

This application claims a benefit, under 35 U.S.C. §119(e), of U.S. Provisional Application Ser. No. 61/471,991, filed 5 Apr. 2011, the entire contents and substance of which are hereby incorporated by reference as if fully set forth below.

### TECHNICAL FIELD

Various aspects of the present invention relate to survey systems and methods, more particularly, to systems and methods for surveying remote entities through mobile computing devices.

### BACKGROUND

News has always been a social activity, and recent research regarding consumers of news indicates that a growing segment of people want to actively participate in news-making. In one United States survey, 37% of internet users either posted links on social media sites, tagged content, created their own news information, or micro-blogged (e.g. Twitter) about news. (Purcell, Kristen et al., Understanding the Participatory News Consumer. Pew Internet & American Life Project, Mar. 1, 2010.) This presents an opportunity to create new types of news experiences that enable audiences to engage with topics of the day. Of internet users, 36% indicate that being able to interact with news content, through graphics or other means, was important to them. Id.

### SUMMARY

Current methods of survey collection, including public opinion gathering, do not enable respondents to express their opinions in rich qualitative ways or to challenge the framing of topics or issues in the construction of surveys and methods. As well, current methods of representing and disseminating survey results prohibit respondents and discussants from easy access to the diversity and range of data in the analysis and presentation of topics, including public issue debate.

There is a need for survey systems and methods that efficiently transmit surveys to remote participants at various locations, and that receive both quantitative and qualitative responses coupled together. Exemplary embodiments of the present invention are directed toward such systems and methods.

An exemplary survey system may be enabled to ask people not only what they think, but also why. The survey system may couple a quantitative survey with qualitative data and, in some embodiments, associate responses with respondent locations.

Some aspects of the survey system may be implemented on a mobile computing device, such as a mobile telephone. The survey system may comprise a survey server that may push out surveys as desired to the mobile phones to rapidly gather a rich collection of viewpoints from respondents at the phones. In some exemplary embodiments, surveys on the mobile phones may enable respondents to record media, such as audio or video, as part of their survey responses. The survey responses may be collected in real-time and may be geo-coded with the locations of the surveyed entities.

The received survey responses may be visualized for discussion, for example, on maps or scatterplots. A presentation environment may be included in the survey system, and may comprise, for example, a broadcast studio or a website for data distribution. Through the presentation environment, survey results may be delivered to the public or to a private group of entities.

These and other objects, features, and advantages of the survey system will become more apparent upon reading the following specification in conjunction with the accompanying drawing figures.

### BRIEF DESCRIPTION OF THE FIGURES

FIG. 1 illustrates a first diagram representing the survey system, according to an exemplary embodiment.

FIG. 2 illustrates an exemplary survey of the survey system, as provided to a mobile computing device, according to an exemplary embodiment.

FIG. 3 illustrates an architecture of a mobile computing device useable with the survey system, according to an exemplary embodiment.

FIG. 4 illustrates an architecture of a survey server of the survey system, according to an exemplary embodiment.

FIG. 5 illustrates a broadcast configuration of the survey system, according to an exemplary embodiment.

FIG. 6 illustrates an example graphical representation of survey results, according to an exemplary embodiment.

FIG. 7 illustrates a method of how user-provided qualitative responses are captured using a mobile computing device with the survey system, according to an exemplary embodiment.

### DETAILED DESCRIPTION

To facilitate an understanding of the principles and features of the present invention, various illustrative embodiments are explained below. Exemplary embodiments of the invention comprise survey systems enabling remote, on-demand surveying. In particular, embodiments of the survey system are described in the context of being used along with a broadcast studio, so that results may be broadcast after being collected in real-time. Embodiments of the invention, however, are not limited to this context. Rather, embodiments of the invention may provide surveying for many purposes and results may be accessible in various ways. For example, and not limitation, survey results may be made accessible on a website, or through another type of presentation environment, instead of being broadcast using a studio configuration.

The components described hereinafter as making up various elements of the invention are intended to be illustrative and not restrictive. Many suitable components that would perform the same or similar functions as components described herein are intended to be embraced within the scope of the survey systems and methods. Such other components not described herein may include, but are not limited to, for example, components developed after development of the invention.

Various embodiments of the invention are survey systems and methods useable with media broadcasts, which may present qualitative video, audio, image, or text material collected during surveying. An exemplary survey system may provide a robust platform for surveying a collection of remote participants, and may be associated with or include a presentation environment, or presentation system. The remote participants may provide quantitative and qualitative survey feedback to potentially influence real-time on-air content.

In an exemplary embodiment, the presentation environment may take many forms. For example, it may include a broadcast studio environment, which may have a touch-sensitive tabletop display, one or more cameras, and one or more display screens. The studio environment may be supported by associate producers who monitor participant submissions via the survey system, as well as a television control room where a technical director calls which participant submissions and other media are presented on air. Alternatively, the presentation environment may comprise a website or other system configured to provide survey results.

The survey system may be associated with a server, which may be located at or in communication with the presentation environment. Surveys may be submitted to the survey system and delivered to one or more remote instances of a survey application. The survey application may be installed or otherwise executed on one or more mobile devices. Participants may receive the surveys on the survey application on the mobile devices. In response to a survey, a participant may provide quantifiable survey responses, and may also record video or audio content, coupled with quantifiable survey items, as part of his response to the survey.

The presentation environment may receive the survey responses, including submitted video or audio content, and those responses may be selectively broadcast or otherwise presented as desired.

Referring now to the figures, wherein like reference numerals represent like parts throughout the views, various embodiments of the survey systems and methods will be described in detail.

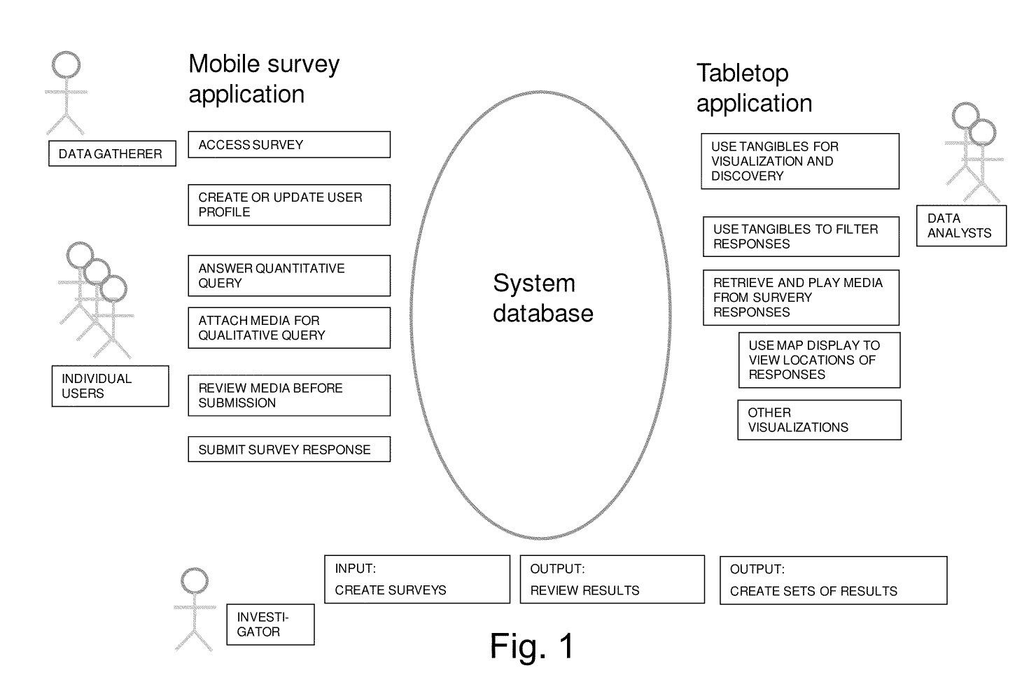

FIG. 1 illustrates a diagram of an exemplary survey system 100, according to an exemplary embodiment of the present invention.

As shown in FIG. 1, the survey system 100 may provide surveys to various instances of a survey application 110, also referred to herein as a mobile survey application, which may be installed on remote computing devices. These devices may include mobile phones, tables, laptop computers, desktop computers, or other computing devices that are located remotely from one another and, preferably, remotely from a central system that compiles the results. In an exemplary embodiment, the mobile survey application 110 may be configured to run on mobile telephones or other mobile computing devices, so that users may access surveys regardless of their locations, when a survey is activated and transmitted to the remote computing devices.

The mobile survey application 110 may have at least two modes: an individual mode and a data-gathering or investigator mode. The individual mode may be installed, or otherwise run, on computing devices of individual survey respondents. After such a respondent enters his responses for a particular survey into the mobile survey application 110, in the individual mode, the mobile survey application 110 may restrict future access to that survey. For example, the application 110, possible working in communication with the database 120, may prohibit the viewing or retaking of the survey with the same computing device. In contrast, if using data-gathering mode, the mobile application 110 may allow multiple sets of responses to each survey. Presumably, this mode may be used by an individual who collects responses from multiple other people, as would a “man on the street” or reporter.

As shown in FIG. 1, to become initiated for receiving surveys, the mobile survey application 100 may present a user profile for the respondent to complete. The profile responses may be transmitted to a system database 120, so that they may later be used to determine which potential respondents receive which surveys, or so that they may be used to characterize the respondent's future survey responses.

Each survey may be a poll, a questionnaire, or other form of querying users for information. In the survey system 100, a survey may include one or more quantitative queries and one or more qualitative queries. In some instances, a query may be a compound, two-part query comprising both a quantitative query and a qualitative query, coupled together and directed toward a related issue. For example, and not limitation, the qualitative query may provide the mechanism to answer “Why?” as follow-on to a related quantitative query. A survey may comprise a combination of one or more two-part queries, individual quantitative queries, or individual qualitative queries, although in an exemplary embodiment, all queries within a single survey are related in some manner.

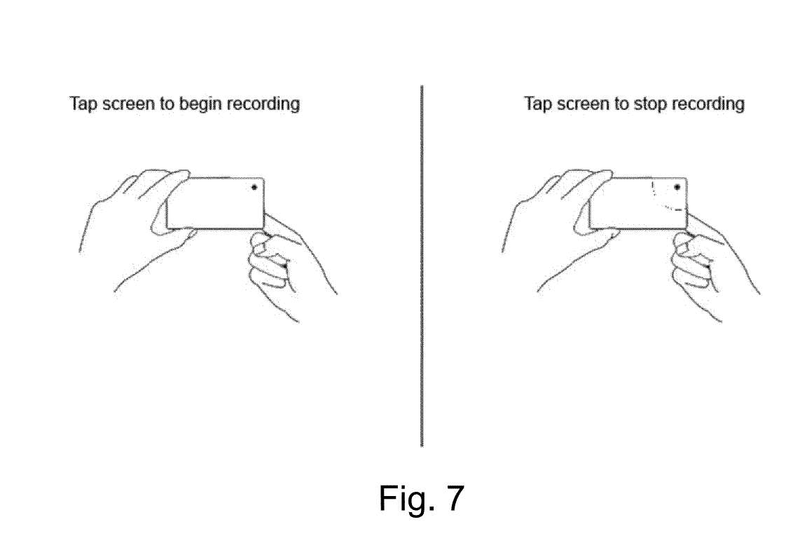

Each quantitative query may be a question or statement having two or more predetermined answer choices, where the respondent may be asked to select one or more of the answer choices. As a result of the answer choices being predetermined, the respondent's selections may be quantifiable and easily compared to selections of other respondents. Each qualitative query may provide an option to include a user-provided entry not selected from a set of predetermined answer options. In some embodiments, when the respondent opts to respond to the qualitative query, the mobile survey application 110 may automatically initiate a media recording to capture the user-provided entry, which may be, for example, in the form of video, audio, image, or text. In some instances, such initiation may require access to hardware of the computing device on which the mobile survey application 110 runs. As shown in FIG. 7, for example, the mobile survey application 110 may enable the respondent to turn a mobile device camera, on the mobile computing device, toward himself, tap the screen once to start video recording, and tap the screen once again to stop recording. Accordingly, a qualitative media response may be coupled to the qualitative query in the respondent's survey result.

For each survey sent to the mobile application 110, the associated respondent may provide responses selected from among predetermined possible answers. In some embodiments, the mobile survey application may also provide a means for the respondent to provide non-quantitative responses in the form of one or more media. For example, and not limitation, the mobile survey application 110 may provide space for the respondent to type additional thoughts or a narrative answer to a question; may be enabled to accept an audio clip recorded at the computing device; or may be enabled to accept a video clip recorded at the computing device. The respondent's qualitative response may be included as part of the response to the survey, and transmitted back to a remote location, such as the database 120, for compilation with survey responses from others.

It will be understood that, although the term “database” is used herein, embodiments of the survey system 100 are not limited to certain types of databases or certain organizations of data. Rather, throughout this disclosure, this term will be understood to refer to one or more of various data storage systems, such as, for example, a relational database or a set of one or more text or XML files. Further, the database 120 need not be at a central location, but may instead be distributed across a plurality of storage devices or locations.

A research investigator may create the surveys and initiate their transmission to the mobile survey applications 110. In some embodiments, the research investigator may create surveys on-demand, while a broadcast is in progress, and transmit the surveys during the broadcast for efficient surveying. Each survey may have one or more queries and, in some embodiments, a start date and an expiration date.

The research investigator may retrieve from the database 120 the survey results from the various respondents. The research investigator may organize the results into a visual form for delivery to other entities.

In some embodiments, the survey results (e.g., results of an opinion poll) may be viewable through a presentation environment 130, such as a broadcast studio, which may comprise a tabletop application and one or more tangibles. The tangibles may be used in conjunction with the tabletop to arrange aggregate and individual data points to discover relationships in the survey data. A user of the tabletop may select individual or groups of data points to be presented on one or more broadcast screens. This may include presentation of the videos or other media included with the survey responses.

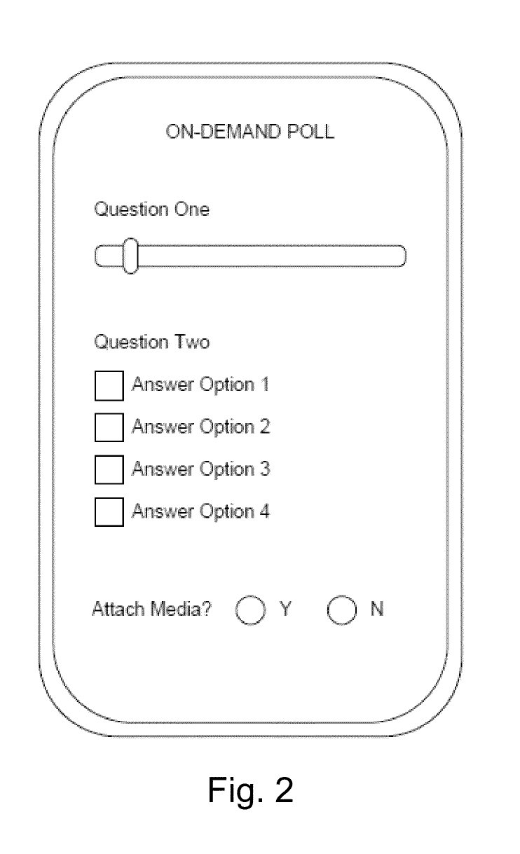

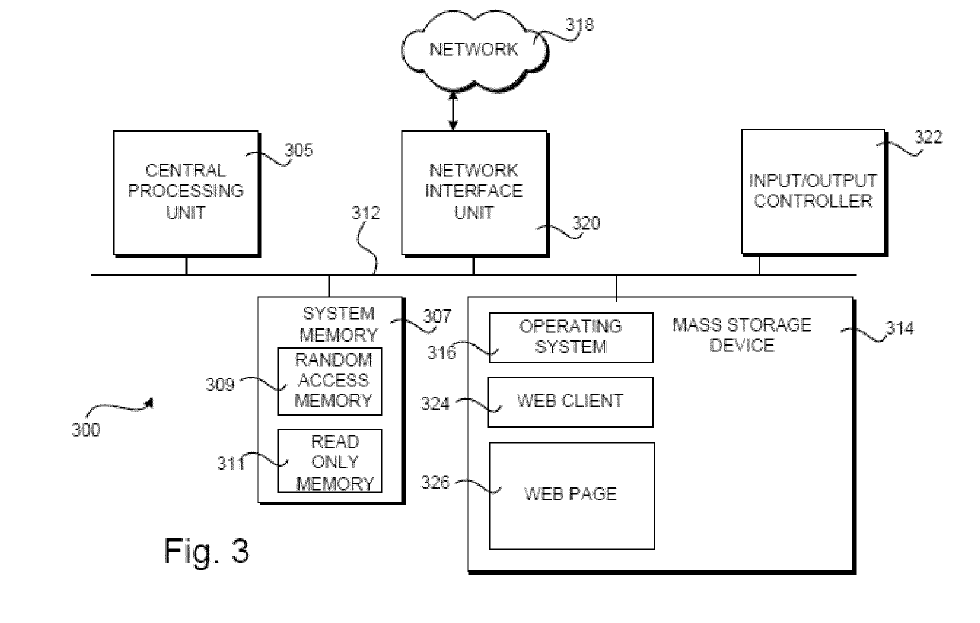

FIG. 2 illustrates an exemplary survey of the survey system 100, as provided to a mobile computing device 300 (see FIG. 3), according to an exemplary embodiment. As shown in FIG. 2, a survey provided through the mobile survey application 110 may comprise various query formats, as deemed fit by the investigator or other involved party. Additionally, a survey need not only ask quantitative queries (e.g., accepting answers via Likert scale, radio buttons, or check boxes), but may also enable the respondent to attach media to the survey response.

To use the mobile survey application 110, first the respondent may be required to log into the system 100 or register a remote computing device, by entering an existing username and password, or by creating a new account. Associating submissions with user accounts may allow for saved preferences, user banning, and user identification on the table application, including privacy settings. After the user presses a submission button to submit his information, the mobile survey application 110 may asynchronously open a stream to a PHP file on a server, and may thereby transmit a user-provided username and password, as well as the account type (new or existing), in XML or other format. The PHP file may query the database 120 to confirm an existing user or create a new one, and may send a response to the application. The respondent may then be informed of invalid inputs through pop-up notifications. It will be understood that other forms of communication and storage may be used in place of PHP files and XML, which are discussed herein for illustrative purposes only.

For each survey provided to a respondent, the application 110 may display statements, retrieved from the database 120 through a connection to a PHP file, concerning different aspects of a given survey subject. For example, an exemplary statement is: “Health reform should include a public option insurance plan.” Multi-point sliders may be dynamically provided beneath each statement. The user may record his opinion about each statement by dragging the handle of the corresponding slider. The response may be framed in the form of a Likert scale, and the selected value, e.g., “somewhat agree,” may be displayed proximate the slider, providing feedback to the user. Other question formats may also be provided in a survey.

In some embodiments, the survey application may enable the user to provide a qualitative response to each survey or query, or to each survey or query specifically tagged by the investigator as being open to qualitative responses. If the respondent decides to provide such a response, that response may be recorded as media by the computing device and attached to the survey by the mobile survey application 110. For example, and not limitation, the user may attach an audio recording or a video recording. Upon receiving an indication that the respondent desires to provide such a response, the mobile survey application 110 may automatically access hardware on the computing device as needed to capture the respondent's qualitative response. In some instances, this may require automatically opening another application, such as a camera application, on the computing device.

The mobile survey application 100 may store the survey response locally, transmit it to a remote location, such as to the database 120, or may both store it and transmit it. After submitting his opinions, the respondent may be prompted by the application 110 to confirm a detected location (geocoded to a city name) or enter a different one. The location may be detected by various means available to the computing device on which the mobile survey application 110 is running. For example, GPS or cell towers may be used to detect location.

When the respondent submits his response to a survey, various data corresponding to that response may be transmitted to a remote location, such as the database 120 for storage, later retrieval, or analysis. The transmitted data may include, for example, user identification, latitude, longitude, viewpoint ID (e.g., political party affiliation), and opinion values gathered in the survey. In some embodiments, this data may be combined into an XML- or JSON-formatted string and included with a timestamp.

A connection may be opened to a PHP file, and the data string may be transmitted and parsed into the database 120. Each submission may be stored at the database 120 as an entry in a table that contains user, viewpoint, location, and time information. The respondent's opinions, which may be represented as values from −5 (strongly disagree) to 5 (strongly agree), may be stored in a separate table where they are associated with specific submissions. Each entry in the opinion table may represent a respondent's opinion about a single topic statement, with additional tables for other data.

Various aspects of the survey system 100 may be embodied, in whole or in part, in one or more non-transitory computer-readable medium for execution by a computer processor. For example, the mobile survey application 110 may be stored on a media card or internal storage drive of a mobile computing device, such as a mobile phone.

FIG. 3 illustrates an exemplary architecture for such a mobile computing device 300. The computing device 300 may be used to run the mobile survey application 110. Those skilled in the art will recognize that the general architecture described in reference to FIG. 3 is for example only, and may be modified to accommodate various embodiments of the survey system 100.

As shown in FIG. 3, the computing device 300 may comprise a central processing unit 305 (“CPU”) and one or more system memories 307, such as a random access memory 309 (“RAM”) and a non-volatile memory, such as a read-only memory (“ROM”) 311. The computing device 300 may further comprise a system bus 312 coupling together the memory 307, the CPU 5, and various other components. A basic input/output system containing routines to assist in transferring information between components of the computing device 300 may be stored in the ROM 311.

The computing device 300 may comprise, or may be associated with, various forms of computer-readable media. One such form of computer-readable media may be embodied in a mass storage device 314. Although the description of computer-readable media contained herein generally refers to a mass storage device 314, such as a hard disk or CD-ROM drive, it will be appreciated by those skilled in the art that computer-readable media may include many available media accessible by the computing device 300, such as flash storage or a media card installed in a mobile phone. The mass storage device 314 may store an operating system 316, application programs, and other program units. The mass storage device 314 may be connected to the CPU 305 through a mass storage controller (not shown) connected to the bus 312. The mass storage device 314 may provide non-volatile storage for the computing device 300.

Computer-readable media may include computer storage media, such as volatile and non-volatile, removable and non-removable media implemented in many methods or technologies for storage of information, such as computer-readable instructions, data structures, program units, or other data. Computer storage media may include, but is not limited to, RAM, ROM, EPROM, EEPROM, flash memory, other solid state memory technology, CD-ROM, digital versatile disks (“DVD”), other optical storage, magnetic cassettes, magnetic tape, magnetic disk storage, other magnetic storage devices, or many other media that may be used to store the desired data and may be accessible by the computing device 300 or the server assembly 400. Computer-readable instructions on the storage media of the computing device 300 may include, for example, instructions for implementing processes, preferably client-side processes, of the survey system 100.

According to various embodiments, the computing device 300 may operate in a networked environment using logical connections to remote computers, such as the survey server or the database 120, through a network 318, such as the Internet. The computing device 300 may connect to the network 318 through a network interface unit 320 connected to the bus 312. It will be appreciated that the network interface unit 320 may also be utilized to connect to other types of networks and remote computer systems.

The computing device 300 may also include an input/output controller 322 for receiving and processing input from a number of other devices, including a keyboard, mouse, touch-sensitive surface, or electronic stylus. The input/output controller 322 may provide output to a display screen, a printer, or other type of output device.

A number of program units and data files may be stored in the mass storage device 314 and RAM 309 of the computing device 300. Such program units and data files may also include an operating system 316 suitable for controlling operations of a networked mobile phone or personal computer. A web browser application program, or web client 324, may also be stored on the mass storage device 314 and the RAM 309. The web client 324 may comprise an application program for requesting and rendering web pages 326 created in Hypertext Markup Language (“HTML”) or other types of markup languages. The web client 324 may also be capable of executing client side objects, as well as scripts through the use of a scripting host. The scripting host executes program code expressed as scripts within the browser environment. In some embodiments, the mobile survey application 110 may be a web-based application, in which case it may be executed on the computing device 300 through the web client 324.

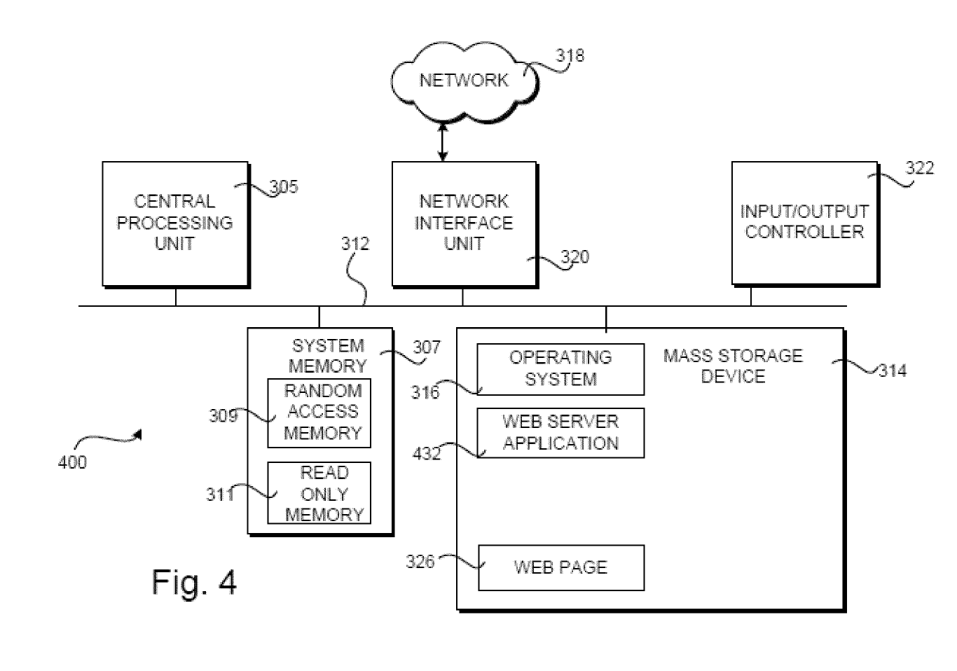

Referring now to FIG. 4, a survey server 400 utilized in various exemplary embodiments of the survey system 100 is illustrated. The survey server 400 may service a website 310, if one is provided, by receiving and responding to requests from web clients 324. The server assembly 400 may comprise various combinations of hardware and software for servicing the website 310 or for transmitting surveys to remote instances of the mobile survey application 110. Those skilled in the art will recognize that the survey server 400 illustrated in FIG. 4 is an exemplary server configuration and may be modified to accommodate various embodiments of the survey system 100. As shown in FIG. 4, the survey server 400 may include many of the conventional computing components included in the computing device 300 and described above with respect to FIG. 3. In particular, the server assembly 400 may include a CPU 305, a network interface unit 320 connected to a network 318, such as the Internet, a system memory 307, and a mass storage device 314.

The mass storage device 314 utilized by the server assembly 400 may typically be operative to store an operating system 316 suitable for servicing a website 310 or transmitting surveys to a plurality of remote locations. The mass storage device 314 and its associated computer-readable storage media may provide non-volatile storage for the survey server 400. Computer-readable instructions on computer-readable storage media of the survey server 400 may include, for example, instructions for implementing processes, preferably server-side processes, of the survey system 100.

The server assembly 400 may utilize a web server application 432. The web server application 432 may receive and respond to requests from web clients 324 at the remote computing devices 300, for web pages 326 located at or accessible to the server assembly 400. It will be appreciated that web pages 326, as described herein, include both those pages stored statically and utilizing only HTML, as well as pages generated dynamically through use of server-side scripting technologies.

It will be further understood that, in some embodiments in which a website is provided, separate servers 400 may be used for transmitting surveys to the computing devices 300 and for servicing the website.

The survey system 100 may comprise or otherwise be associated with a presentation environment 130. In some embodiments, the broadcast system 130 may simply be a website configured to access the database 120 and provide survey data to website users upon request.

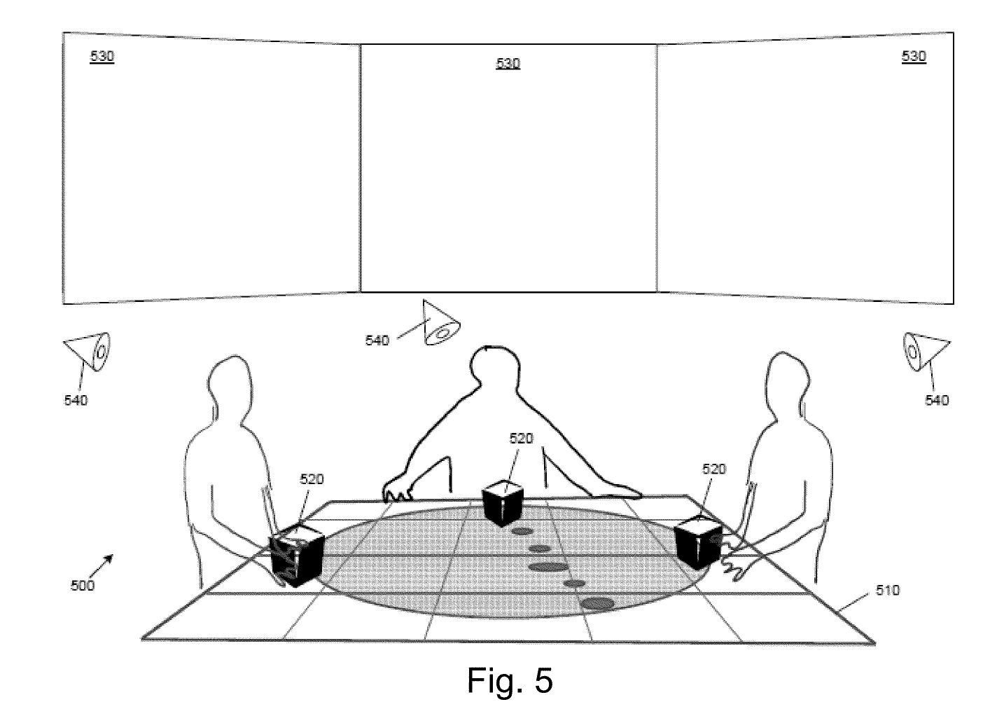

In some other exemplary embodiments, the presentation environment 130 may comprise a broadcast studio 500, such as the one illustrated in FIG. 5. As shown in FIG. 5, the broadcast studio may include an interactive table 510, one or more tangibles 520 for use with the table 510, one or more displays 530, and one or more cameras 540.

As seen in FIG. 5, a central component of the studio environment 500 is the interactive table 510, where a leading discussant may interact with the survey system 100 via multi-touch and tangibles 520. In some exemplary embodiment, the table may utilize the hardware setup of the Tangible Tracking Table developed at the Synaesthetic Media Lab (Wu, C. S., Mazalek, A., Tangible Tracking Table: an interactive tabletop display, IEEE Workshop on Tabletops and Interactive Surfaces '08 Posters, Amsterdam, the Netherlands, Oct. 1-3, 2008), based on the reacTlVision framework (Kaltenbrunner, M. and Bencina, R., Reactivision: A computer-vision framework for table-based tangible interaction, in Proceedings of the 1st international conference on Tangible and Embedded Interaction (TEI '07) (Baton Rouge, La.), ACM, New York, N.Y., 69-74, 2007).

The tangibles may use “fixed” or “changeable” tangibles; the changeable aspect being the functionality to change the text displayed on the tangible, thus also changing how the underlying database is queried, as well as the resulting display.

The interactive table's graphical display may be output onto the center display 520 above the table 510, so that it is easily visible to studio cameras and thus program viewers. In some embodiments, the graphical display may also, or alternatively, be output to one or more control room video feeds, if switching to a feed from the table's display is desired on-air. The two side screens, if provided, may receive output from separate computers that house viewer submitted video content in response to mobile surveys provided through the mobile survey application 110.

The studio environment 500 may support three discussants, or various other numbers, with the person located along the back long side of the table 510 being the primary user of the tangibles 520, which may operate on graphic visualizations featured on the table 510. Possible graphic visualizations on the table 510 may include novel interactive graphical visualizations of the data, for example: a geographic map representation, the “Map View,” and a novel representation referred to herein as the “Debate Circle.” Various different types of tangibles 520 may be used for interaction, including, for example, a Topic Tangible, several Viewpoint Tangibles, a Mode Tangible, a Question Tangible, an Answer Tangible, and other types of tangibles for filtering or selecting aspects of the data set.

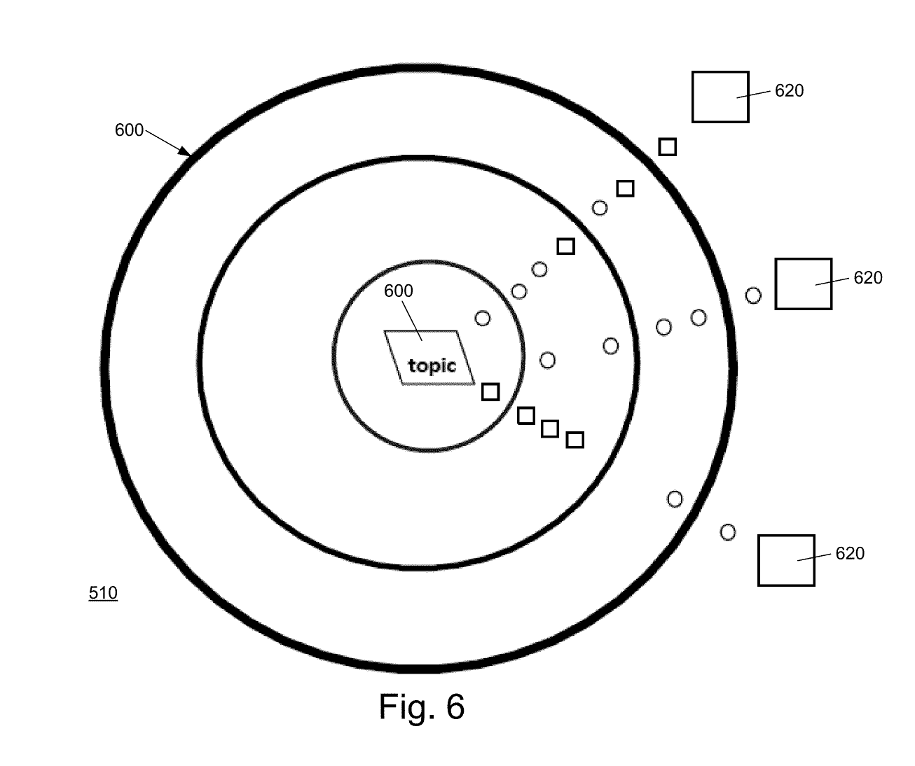

FIG. 6 illustrates an example of the Debate Circle 600 representation of survey results, according to an exemplary embodiment. It will be understood that FIG. 6 is not a limiting example, and the Debate Circle 600 and interactions with it may be implemented in alternative ways as well. In FIG. 6, each small circle or square represents a survey response from a respondent. The squares are responses with video or other media attachments in response to qualitative queries related to the topic, while the circles represent survey responses with no such media attachments. The locations of the Topic Tangible 610 and the Viewpoint Tangibles 620 are detectable by the interactive table 510, and the relative positions of these tangibles determines the arrangement of the various graphical components on the table 510. In an exemplary visualization of responses to a Likert-scale query, the data points, i.e., survey results, of respondents who agree with, or answered positively to, a query are positioned closer to the Topic Tangible 610 than the data points of those who do not agree, or answered negatively. When the interactive table 510 detects a touch, or other detectable interaction, at the location of one of the data points with media attachment, the presentation system 130 may play the media attachment as a result of the touch.

The Topic Tangible or Question Tangible may represent the subjects under discussion and may be used to select the topics or questions of interest, e.g. “Obama's Leadership” or “Should We Be Required to Have Mandatory Insurance?” The Viewpoint Tangibles may be used to represent viewpoints on different topics, for example, to filter and control the submissions by political party affiliation: Republican, Democrat, or Independent. The Mode Tangible may be used to change between different data visualizations, such as the Map View and Debate Circle graphic representation modes.

The Map View may display the submissions from remote survey participants on a geographic map, such as in the form of colored graphic markers, representing party affiliation, according to the latitude and longitude from which they were submitted. Media performers or other discussants may use the Topic Tangible to change the topic currently under discussion. This may be accomplished by selecting from a list of available topics shown on the screen using finger touch. When one adds a Viewpoint Tangible to the table, such as the Democrat tangible, the survey system 100 may display submissions from affiliated individuals.

Survey response submissions may be comprised of both numerical data and media attachments, in which participants may have explained their choices on a particular survey item. Discussants may distinguish which submissions have videos by the type of graphic marker displayed by the interactive table 510, and may select to play out the videos on the screens behind the interactive table 510 using finger touch or infrared pens to interact with the table 510.

When the Debate Circle visualization is used (see FIG. 7), submissions are rearranged into concentric circles around the Topic Tangible according to the degree to which the survey respondent agreed or disagreed with the item, with agreement closer to the center. The Viewpoint Tangibles can be placed onto or removed from the Debate Circle to filter the submissions, for example to compare how viewers with different political party affiliations feel about a given topic. When discussants at the table move the Viewpoint Tangibles, the responses may appear along a line from topic tangible to viewpoint tangible, allowing a comparison of the range of responses by viewpoint when two or more Viewpoint Tangibles are moved side-by-side. This may allow more nuanced comparisons of public opinion than the characteristically polarized presentation of views, e.g. in charts and graphs.

In the Map View mode, submission positions may be fixed on a geographic map based on associated location data. In the Debate Circle mode, each submission may be displayed at a position within a fixed radius around the Topic Tangible. This radius may be determined by the attached opinion value associated with the topic on the tangible 520. In some embodiments, the survey system 100 may apply forces to the submission markers displayed on the table 110 to keep the markers within a predetermined, fixed distance from the Topic Tangible, even as the leading discussant moves the topic tangible. Alternatively, or additionally, viewpoints may be arranged in proportional distances from the center in a line from topic to viewpoint, which may be moved about to enable access to data and comparisons.

The Topic Tangible, which may allow the leading discussant to change the topic of the submissions viewed, may be a mobile computing device, such as a smartphone. The device may run an application that connects to the interactive table 510, such as through a wireless network. When a topic is selected, a message may be transmitted to the table 510 informing it of the new topic, and the device's display may be updated accordingly. Similarly, submissions displayed on the table 510 may be updated to reflect the new topic.

In one exemplary use of the survey system 100 and associated studio environment 500, two to three on-air personalities interact with the tangible table 510, which features a multi-touch surface and tangible controls that change the table's graphic content, which is also output to the central section of a three-section set of displays 530 behind the table 510. The left and right displays are used to display user-provided qualitative responses or other content, such as brief videos agreeing or disagreeing with a point. The output of the table 510 and what is seen on a display 530 may be switched to a broadcast feed upon request, which is a common broadcast technique.

The program begins with the anchor, the leading discussant, letting viewers know that the broadcast team will be discussing both randomly administered and user-self-selected opinion surveys, and that during the show, viewers may participate in one or more surveys using their phones, the web, or cable television applications. The anchor begins the discussion by presenting a summary graph on a particular topic, for example, whether people agree or disagree with the statement “I approve of the way in which the President is leading the health reform work.” Next, the anchor suggests taking a closer look at who across the country contributed to this overall picture, by activating on the interactive table 510 a map representation for all data points. This is done by placing a tangible control, the Topic Tangible, onto the table 510. The Topic Tangible is a mobile phone with a list of topics on its display, and when one topic is picked, it is legible to the studio camera 540 with an over-the-shoulder shot of the anchor and table 510.

Next, the anchor pulls up data points on a map graphic by adding Viewpoint Tangibles, representing additional key aspect of the submissions. In this exemplary scenario, the additional key aspects include the participating viewers' political affiliations: Republican, Democrat, or Independent. The Viewpoint Tangibles and their data points are coded in appropriate colors to match these affiliations, e.g., red, blue, and yellow respectively. Data points representing submissions that have videos as well as numerical data are noted with a symbol in addition to their color.

The anchor previews the viewer-provided video submissions by touching them, which brings up metadata (e.g. agree/disagree), and can play them out by prolonging the touch. Participant-recorded videos play out on different sides of the screen according to their agreement or disagreement with a survey statement.

During this time, the anchor may discuss what the viewers have said with the other on-air personalities. After examining what has been submitted by geographic area, the anchor may go to additional graphical representations, such as the Debate Circle view, which arranges submissions around a given topic according to their level of agreement or disagreement.

Viewers may engage with the on-air programming by downloading the mobile survey application 110 to their mobile phones, on which they receive invitations to take surveys and submit videos about why they hold particular opinions. In this example, these surveys are pushed to viewers in advance of programs, and may be tied to topics for which viewers have indicated they have an interest. Alternatively, however, surveys may be pushed out on-demand as the broadcast develops.

One important aspect of designing for mass-mediated, user-generated content is the issue of scale; invitations to contribute submissions could result in thousands of responses. As the inventors of this application researched methods of visualizing this volume of entries, they recognized that it would be advantageous to collect user-generated survey content that had a quantitative as well as qualitative aspect, so that overviews of patterns of responses from viewers could be presented in visualizations.

With regards to qualitative content, such as user-created videos, there are a number of problems that were considered by the inventors, primarily the need to screen entries prior to airing them, as they could contain inappropriate or off-topic content. A short-run solution is to have entries pulled randomly and screened by broadcast assistants prior to release to the live system. A further step would be to create a complimentary online recommender system to engage the viewer community in grading the entries according to a point value scheme, or simply according to whether they “like” the entries or find them helpful.

The changeable Topic Tangible may repurpose a device like those on which viewers submitted their opinions, as a device to drive the playback of survey submissions by topic on the tangible table 510. Selecting a phone as a tangible 520 may enable leveraging its protocols to communicate with the table 510, and may thus eliminate the need for creating multiple single-topic tangibles 520. In some embodiments, the table 510 makes use of two main methods of input, tangibles 520 that have a pattern on the bottom that is read by computer vision, and the changeable tangible, which, in addition to its pattern, provides input by wireless network.

Various embodiments of the survey system 100 and associated methods may enable the didactic delivery of information combinable with interaction techniques allowing for real-time discovery of trends or nuances in viewer-provided content. The survey system 100 may thus be considered a step toward a movement from show and tell to co-creation of news.

While the survey system 100 has been disclosed in exemplary forms, it will be apparent to those skilled in the art that many modifications, additions, and deletions may be made without departing from the spirit and scope of the system, method, and their equivalents, as set forth in the following claims.

What is claimed is:

1. A survey system comprising:
a survey server configured to transmit a survey to a plurality of remote computing devices, and to receive a plurality of responses to the survey from the plurality of remote computing devices, wherein the survey comprises:
at least one quantitative query, each quantitative query providing two or more predetermined answer options; and
a qualitative query coupled with the quantitative query and providing an option to include a user-provided entry not selected from a set of predetermined answer options; and
a survey application executable on the plurality of remote computing devices and configured to present the survey to a plurality of users at the plurality of remote computing devices.

2. The survey system of claim 1, further comprising a presentation environment configured to provide a graphical representation of the responses to the survey, wherein the responses having user-provided entries are distinguishable from the remainder of the other responses in the graphical representation.

3. The survey system of claim 2, the presentation environment comprising a website or software application.

4. The survey system of claim 2, the presentation environment being a multi-touch-sensitive display device in a broadcast studio environment.

5. The survey system of claim 1, the survey server being configured to select the plurality of remote computing devices, from a larger group of available remote computing devices, as being eligible to receive the survey based at least in part on profile data associated with the plurality of remote computing devices.

6. The survey system of claim 1, the survey application being configured to execute on a first computing device of the plurality of computing devices, to present the quantitative query as a question or statement along with the two or more predetermined answer options, and to receive a selection of at least one of the predetermined answer options.

7. The survey system of claim 6, the survey application being further configured to initiate a video recording at the first computing device, to capture a video as the user-provided entry to the qualitative query.

8. The survey system of claim 7, the survey application being further configured to transmit the captured video and the selection of at least one of the predetermined answer options to the survey server as a first response to the survey.

9. The survey system of claim 8, the survey application being further configured to transmit a location of the first remote computing device along with the first response to the survey.

10. The computer program product of claim 1, the survey application being configured to execute on a first computing device of the plurality of computing devices and comprising an individual mode and an investigator mode, wherein in the individual mode, the survey is presentable no more than a single time on the first computing device, and wherein in the investigator mode, the survey is presentable a plurality of times on the first computing device.

11. A computer program product embodied in a non-transitory computer readable medium, the computer program product configured to effectuate a survey method comprising:
receiving a survey comprising:
at least one quantitative query, each quantitative query providing two or more predetermined answer options; and
a qualitative query providing an option to include a user-provided entry not selected from a set of predetermined answer options;
transmitting the survey to a plurality of remote computing devices;
receiving a plurality of responses to the survey from the plurality of remote computing devices, wherein at least a first response comprises a first user-provided entry in answer to the qualitative query.

12. The computer program product of claim 11, the first user-provided entry comprising a video, image, or audio attachment.

13. The computer program product of claim 11, the first user-provided entry comprising a textual narrative.

14. The computer program product of claim 11, the survey method further comprising receiving profile data related to a plurality of the users associated with the plurality of remote computing devices.

15. The computer program product of claim 14, the survey method further comprising:
selecting the plurality of users to receive the survey, wherein the plurality of users is selected from a larger group of users, based on the profile data related to the plurality of users; and
transmitting the survey to the plurality of users based on the selection.

16. A computer program product embodied in a non-transitory computer readable medium, the computer program product configured to effectuate a survey method comprising:
receiving a survey comprising:
at least one quantitative query, each quantitative query providing two or more predetermined answer options; and
a qualitative query coupled with the quantitative query and providing an option to include a user-provided entry not selected from a set of predetermined answer options;
presenting the quantitative query to a user as a question or statement, along with the two or more predetermined answer choices;
receiving a selection of at least one of the predetermined answer choices; and
initiating a media recording to capture the user-provided entry to the qualitative query.

17. The computer program product of claim 16, wherein initiating the media recording to capture the user-provided entry to the qualitative query comprises initiating a video, image, or audio recording to capture a video, image, or audio for the user-provided entry.

18. The computer program product of claim 17, the survey method further comprising transmitting the video, image, or audio and the selection of at least one of the predetermined answer choices to a remote location in response to the survey.

19. The computer program product of claim 17, the survey method further comprising locally storing the video, image, or audio and the selection of at least one of the predetermined answer choices in response to the survey.

20. The computer program product of claim 18, the survey method further comprising:
detecting a location of the user; and
transmitting the detected location to the remote location in response to the survey.
